(19) United States
(12) Patent Application Publication
(10) Pub. No.: US 2011/0139131 A1
(43) Pub. Date: Jun. 16, 2011

(54) ARRANGEMENT FOR A SUPERCHARGED COMBUSTION ENGINE CONCERNING COOLERS FOR INLET AIR TO AND EXHAUST GASES FROM THE ENGINE

(76) Inventors: Zoltan Kardos, Sodertalje (SE); Erik Soderberg, Stockholm (SE)

(21) Appl. No.: 12/995,717

(22) PCT Filed: Jun. 3, 2009
(86) PCT No.: PCT/SE2009/050654

§ 371 Date: Dec. 2, 2010

(30) Foreign Application Priority Data
Jun. 9, 2008 (SE) 0801346-8

(51) Int. Cl. F02M 31/20; F02M 25/07

(52) U.S. Cl. 123/542

(57) ABSTRACT

An arrangement for a supercharged combustion engine (2), including at least one compressor (6a, 6b) for compressing air in a first cooling system, the first cooling system having a first circulating coolant, a second cooling system with a second circulating coolant which during normal operation of the combustion engine is at a lower temperature than the first coolant in the first cooling system, at least one charge air cooler (9a, 9c) applied in the air inlet line (8) and being cooled by coolant from the second cooling system. The second cooling system includes a first radiator element (24) and a second radiator element (36) arranged in series with the first radiator element (24) in the second cooling system, so that at least part of the coolant which circulates in the second cooling system undergoes two steps of temperature lowering during a single round of circulation in the second cooling system.

### BACKGROUND TO THE INVENTION, AND STATE OF THE ART

The present invention relates to an arrangement for a supercharged combustion engine according to the preamble of claim 1.

The amount of air which can be supplied to a supercharged combustion engine depends on the pressure of the air but also on the temperature of the air. Supplying the largest possible amount of air to a combustion engine requires the air to be at a high pressure and a low temperature when it is led into the combustion engine. When air needs compressing to high pressure, it is advantageous that it be compressed in two stages. This may involve a compressor of a first turbo unit subjecting the air to a first compression step and a compressor in a second turbo unit subjecting the air to a second compression step. Cooling the air between the two compression steps is a known practice. The cooling of the air after it has undergone the first compression step leads to the air being at a lower specific volume, i.e. occupying a smaller volume per unit weight. As a compressor usually has a space with a constant volume in which to receive and compress air, such intermediate cooling makes it possible for a larger amount of air to be drawn into the second compressor and subjected to the second compression step. It is therefore desirable to cool the air between the compressions to as low a temperature as possible. It is also desirable to cool the air after the second compression step to such a low temperature that as large an amount of compressed air as possible can be led into the combustion engine.

### SUMMARY OF THE INVENTION

The object of the present invention is to provide an arrangement for a supercharged combustion engine whereby the compressed air can be cooled to a very low temperature before it is led into the combustion engine.

This object is achieved with the arrangement of the kind mentioned in the introduction which is characterised by the features indicated in the characterising part of claim 1. When air is compressed, it acquires a raised temperature which is related to the pressure to which the air is compressed. When the air is compressed to high pressure, it therefore requires effective cooling for it to be possible for the air to be cooled to a low temperature before it is led to the combustion engine. According to the invention, an arrangement with a second cooling system which may be referred to as a low-temperature cooling system is therefore used. The coolant which cools the air in the charge air cooler can thus be at a low temperature when it is led through the charge air cooler. The charge air cooler is with advantage of the type called counterflow heat exchanger so that the cold coolant led into the charge air cooler comes into contact with the air which is led out from the charge air cooler. With a suitably dimensioned charge air cooler, the charge air can here be cooled to a temperature close to the temperature of the coolant. The charge air can thus acquire a low temperature before it is led into the combustion engine.

According to a preferred embodiment of the invention, the coolant in the second cooling system is intended to be cooled in the first radiator element by air. This provides a simple way for the coolant to undergo good cooling in the first radiator element. A radiator fan is with advantage adapted to providing a forced air flow through the first radiator element to render the cooling of the coolant more effective. It is of advantage, however, if the air is at a temperature which corresponds to the temperature of the surroundings so that as effective cooling as possible of the coolant is achieved in the first radiator element. The coolant in the second cooling system is with advantage adapted to being cooled in the second radiator element by air at the temperature of the surroundings. The coolant can thus be cooled to a temperature close to the temperature of the surroundings. Here again, a radiator fan is with advantage adapted to providing a forced air flow through the second radiator element to render the cooling of the coolant more effective.

According to another preferred embodiment of the invention, the second cooling system comprises a first line with coolant which has been subjected to a first step of cooling by the first radiator element, and a second line with coolant which has been subjected to a second step of cooling by the second radiator element. The second cooling system thus has coolant in the first line at a first temperature and coolant in the second line at a second temperature. The coolant at the different temperatures can be used to cool components and media which have different cooling requirements. The second cooling system comprises with advantage a line which leads coolant back, after use, to the first radiator element. Such a line may bring together and lead the warm coolant from a number of coolers in which the coolant has been used for cooling. The line leads the warm coolant to the first radiator element, in which it is again cooled.

According to another preferred embodiment of the invention, the second cooling system comprises a line adapted to leading coolant to a first charge air cooler, and a line adapted to leading coolant to a further charge air cooler, which lines lead coolant at substantially the same temperature to the respective charge air coolers. When air is compressed to high pressure, it is advantageous to subject it to more than one step of cooling in a number of charge air coolers. In this case, coolant from the second cooling system is therefore used to cool the air in two charge air coolers. The second cooling system may comprise at least one line adapted to leading coolant to the charge air cooler, and at least one line adapted to leading coolant to a radiator to cool some other medium than air. In for example, a vehicle, there are a large number of components and media which it is advantageous to cool by coolant at a low temperature, such as gearbox oil in an oil cooler, refrigerant in an air conditioning system and electrical control units.

According to another preferred embodiment of the invention, the first cooling system is adapted to cooling the combustion engine. It may be advantageous to use the coolant in this existing cooling system to subject the compressed air to a first step of cooling after the air has been compressed. This coolant is certainly at a temperature of 80-100° C. during normal operation, but this temperature is normally definitely lower than the temperature of the compressed air. Thereafter the coolant in the second cooling system can subject the air to a second step of cooling to a low temperature.

According to another preferred embodiment of the invention, the arrangement comprises a return line connecting the exhaust line to the inlet line so that it is possible, via the return line, to recirculate exhaust gases from the exhaust line to the inlet line. The technique known as EGR (Exhaust Gas Recirculation) is a known way of recirculating part of the exhaust gases from a combustion process in a combustion engine. The recirculating exhaust gases are mixed with the inlet air to the combustion engine before the mixture is led to the engine's cylinders. Adding exhaust gases to the air causes a lower combustion temperature which results inter alia in a reduced content of nitrogen oxides NOₓ in the exhaust gases. Supplying a large amount of exhaust gases to the combustion engine also entails effective cooling of the exhaust gases before they are led to the combustion engine. The return line may comprise an EGR cooler adapted to being cooled by coolant from the second cooling system. The exhaust gases can thus undergo cooling to the same low temperature as the circulating air before they mix and are led into the combustion engine.

### BRIEF DESCRIPTION OF THE DRAWINGS

Preferred embodiments of the invention are described below by way of examples with reference to the attached drawings, in which:

FIG. 1 depicts an arrangement for a supercharged diesel engine according to a first embodiment of the invention and

FIG. 2 depicts an arrangement for a supercharged diesel engine according to a second embodiment of the invention.

### DETAILED DESCRIPTION OF PREFERRED EMBODIMENTS OF THE INVENTION

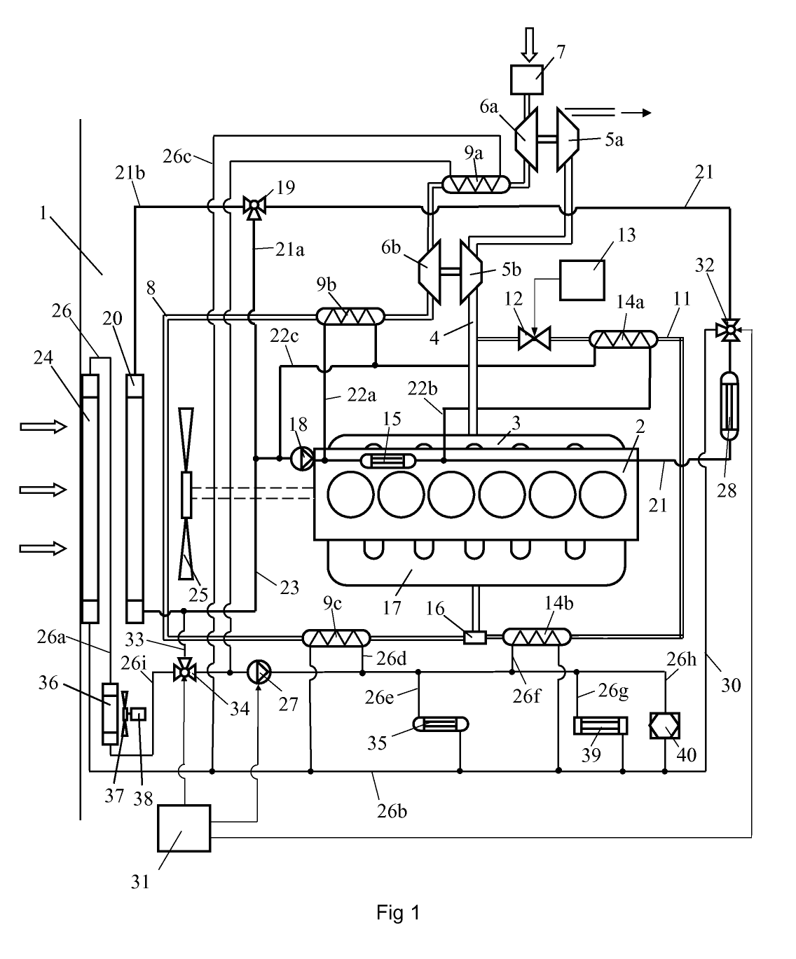

FIG. 1 depicts an arrangement for a supercharged combustion engine intended to power a schematically depicted vehicle 1. The combustion engine is here exemplified as a diesel engine 2. The diesel engine 2 may be used to power a heavy vehicle 1. The diesel engine 2 is cooled by a first cooling system with a circulating coolant. The first cooling system is hereinafter referred to as the combustion engine's cooling system. The exhaust gases from the cylinders of the diesel engine 2 are led via an exhaust manifold 3 to an exhaust line 4. The diesel engine 2 is provided with a first turbo unit comprising a turbine 5a and a compressor 6a, and a second turbo unit comprising a turbine 5b and a compressor 6b. The exhaust gases in the exhaust line 4, which are at above atmospheric pressure, are led initially to the turbine 5b of the second turbo unit. The turbine 5b is thus provided with driving power which is transferred, via a connection, to the compressor 6b of the second turbo unit. The exhaust gases are thereafter led via the exhaust line 4 to the turbine 5a of the first turbo unit. The turbine 5a is thus provided with driving power which is transferred, via a connection, to the compressor 6a of the first turbo unit.

The arrangement comprises an inlet line 8 adapted to leading air to the combustion engine 2. The compressor 6a of the first turbo unit compresses air which is drawn into an inlet line 8 via an air filter 7. The air is cooled thereafter in a first charge air cooler 9a by coolant from a second cooling system. The second cooling system contains coolant which during normal operation is at a lower temperature than the temperature of the coolant in the combustion engine's cooling system. The compressed and cooled air leaving the first charge air cooler 9a is led in the line 8 to the compressor 6b of the second turbo unit, in which it undergoes a second compression step. The air is thereafter led via the line 8 to a second charge air cooler 9b in which it is cooled by coolant from the combustion engine's cooling system. The charge air is finally cooled in a third charge air cooler 9c in which it is cooled by the cold coolant in the second cooling system.

The arrangement comprises a return line 11 for recirculation of exhaust gases from the exhaust line 4. The return line 11 has an extent between the exhaust line 4 and the inlet line 8. The return line 11 comprises an EGR valve 12 by which the exhaust flow in the return line 11 can be shut off. The EGR valve 12 can also be used for steplessly controlling the amount of exhaust gases which is led from the exhaust line 4 to the inlet line 8 via the return line 11. A first control unit 13 is adapted to controlling the EGR valve 12 on the basis of information about the current operating state of the diesel engine 2. The return line 11 comprises a coolant-cooled first EGR cooler 14a for subjecting the exhaust gases to a first step of cooling. The exhaust gases are cooled in the first EGR cooler 14a by coolant from the combustion engine's cooling system. The exhaust gases are thereafter subjected to a second step of cooling in a coolant-cooled second EGR cooler 14b. The exhaust gases are cooled in the second EGR cooler 14b by coolant from the second cooling system.

In certain operating situations in supercharged diesel engines 2, the pressure of the exhaust gases in the exhaust line 4 will be lower than the pressure of the compressed air in the inlet line 8. In such operating situations it is not possible to mix the exhaust gases in the return line 11 directly with the compressed air in the inlet line 8 without special auxiliary means. To this end it is possible to use, for example, a venturi 16 or a turbo unit with variable geometry. If instead the combustion engine 2 is a supercharged Otto engine, the exhaust gases in the return line 11 can be led directly into the inlet line 8, since the exhaust gases in the exhaust line 4 of an Otto engine in substantially all operating situations will be at a higher pressure than the compressed air in the inlet line 8. After the exhaust gases have mixed with the compressed air in the inlet line 8, the mixture is led to the respective cylinders of the diesel engine 2 via a manifold 17.

The combustion engine 2 is cooled in a conventional manner by coolant which is circulated by a coolant pump 18 in the combustion engine's cooling system. The main flow of coolant cools the combustion engine 2. In this case, the coolant also cools motor oil in an oil cooler 15. After the coolant has cooled the combustion engine 2, it is led in a line 21 to an oil cooler element 28 for a retarder. After the coolant has cooled the oil in the oil cooler element 28, it is led on in the line 21 to a thermostat 19. The thermostat 19 leads a variable amount of the coolant to a line 21a and a line 21b depending on the temperature of the coolant. The line 21a leads coolant to the combustion engine 2, whereas the line 21b leads coolant to a radiator 20 fitted at a forward portion of the vehicle 1. When the coolant has reached a normal operating temperature, substantially all of the coolant is led to the radiator 20 in order to be cooled. A line 23 leads the cooled coolant back to the combustion engine 2. A small portion of the coolant in the cooling system is not used for cooling the combustion engine but is led into two parallel lines 22a, 22b. The line 22a leads coolant to the second charge air cooler 9b, in which it cools the compressed air. The line 22b leads coolant to the first EGR cooler 14a, in which it subjects the recirculating exhaust gases to a first step of cooling. The coolant which has cooled the air in the second charge air cooler 9b and the coolant which has cooled the exhaust gases in the first EGR cooler 14a are reunited in the line 22c. The line 22c leads the coolant to a location in the cooling system which is situated between the three-way valve 19 and the pump 18, where it is mixed with cold coolant from the radiator 20.

The second cooling system comprises a line circuit 26 with coolant which is circulated by a pump 27. A radiator element 24 of the second cooling system is fitted in front of the radiator 20 in a peripheral region of the vehicle 1. In this case the peripheral region is situated at a front portion of the vehicle 1. A radiator fan 25 is adapted to generating a flow of surrounding air through the radiator element 24 and the radiator 20. As the radiator element 24 is situated in front of the radiator 20, the coolant in the radiator element 24 is cooled by air at the temperature of the surroundings. The coolant which has been cooled in the radiator element 24 is received in a line 26a. The coolant is at a first temperature in the line 26a. The second cooling system comprises an extra radiator element 36 which is also fitted in a peripheral region of the vehicle 1. A radiator fan 37 is adapted to generating an air flow through the radiator 36. The radiator fan 37 is driven by an electric motor 38. The coolant is cooled in the radiator element 36 by air at the temperature of the surroundings. The coolant which has been cooled in the extra radiator element 36 is received in a line 26i. The coolant is at a lower temperature in the line 26i than in the line 26a. The coolant has with advantage a temperature in the line 26i close to the temperature of the surroundings. A number of parallel lines 26c-h extend from the line 26i. The line 26c leads coolant to the first charge air cooler 9a to cool air which has been compressed by the first compressor 6a. The line 26d leads coolant to the third charge air cooler 9c to cool air which has been compressed by the second compressor 6b. The line 26e leads coolant to an oil cooler 35 to cool gearbox oil. The line 26f leads coolant to the second EGR cooler 14b to cool recirculating exhaust gases. The line 26g leads coolant to a condenser 39 to cool a refrigerant in an air conditioning system. The line 26h leads coolant to a radiator 40 to cool electrical units. The line circuit 26 comprises a line 26b which receives the coolant and leads it back to the radiator element 24 after it has been used for cooling the abovementioned components.

A first connecting line 30 connects the second cooling system to the combustion engine's cooling system. The first connecting line 30 has one end connected to the second line 26b of the second cooling system and an opposite end connected to the line 21 of the first cooling system. The first connecting line 30 is connected to the line 21 via a first three-way valve 32. The coolant in the combustion engine's cooling system is at its highest temperature in the line 21 close to the first three-way valve 32. A second connecting line 33 connects the second cooling system to the first cooling system. The second connecting line 33 is connected to the line 26i of the second cooling system via a second three-way valve 34. The second three-way valve 34 is arranged in the line 26i at a location where the coolant has its lowest temperature in the second cooling system. A second control unit is adapted to controlling the three-way valves 32, 34.

During operation of the diesel engine 2, exhaust gases flow through the exhaust line 4 and drive the turbines 5a, b of the turbo units. The turbines 5a, b are thus provided with driving power which drives the compressors 6a, 6b of the turbo units. The compressor 6a of the first turbo unit draws surrounding air in via the air filter 7 and subjects the air in the inlet line 8 to a first compression step. The air thus acquires an increased pressure and an increased temperature. The compressed air is cooled in the first charge air cooler 9a by the coolant in the second cooling system. In favourable circumstances, the coolant which is led in the line 26c from the second cooling system may be at a temperature close to the temperature of the surroundings when it reaches the first charge air cooler 9a. The compressed air can thus be cooled to a temperature close to the temperature of the surroundings in the first charge air cooler 9a. The cooled air maintains its pressure in the first charge air cooler 9a. Air which is cooled has a lower specific volume, i.e. it occupies a smaller volume per unit weight. The air thus becomes more compact. A compressor normally has a space with a constant volume in which to receive and compress air. The cooling of the air in the first charge air cooler 9a thus makes it possible for a larger amount of air to be compressed in the compressor 6b of the second turbo unit. The air is here subjected to a second compression step to a still higher pressure. The compressed air is thereafter led through the second charge air cooler 9b, in which it is cooled by coolant from the combustion engine's cooling system. The compressed air may here be cooled to a temperature close to the temperature of the coolant in the combustion engine's cooling system. The compressed air is thereafter led to the third charge air cooler 9c, in which it is cooled by coolant from the second cooling system. The compressed air may here be cooled to a temperature close to the temperature of the surroundings.

In most operating states of the diesel engine 2, the control unit 13 will keep the EGR valve 12 open so that part of the exhaust gases in the exhaust line 4 is led into the return line 11. The exhaust gases in the exhaust line 4 may be at a temperature of about 500-600° C. when they reach the first EGR cooler 14a. The recirculating exhaust gases undergo a first step of cooling in the first EGR cooler 14a. The coolant in the combustion engine's cooling system is here used as cooling medium. During normal operation of the vehicle, this coolant will be at a temperature within the range 70-100° C. The recirculating exhaust gases can thus undergo a first step of cooling to a temperature close to the temperature of the coolant. The exhaust gases are thereafter led to the second EGR cooler 14b. The second EGR cooler 14b is cooled by coolant from the line 26i of the second cooling system. With a suitably dimensioned second EGR cooler 14b, the recirculating exhaust gases can be cooled to a temperature close to the temperature of the surroundings. Exhaust gases in the return line 11 can thus undergo cooling to substantially the same temperature as the compressed air in the third charge air cooler 9c.

The compressed air is thus subjected to three steps of cooling. Cooling the air between the compressions in the compressors 6a, b results in the air being of relatively low specific volume when it is subjected to the second compression step by the compressor 6b. A relatively large amount of air can therefore be subjected to the second compression step by the compressor 6b. The compressed air is thereafter cooled in the second charge air cooler 9b and the third charge air cooler 9c to a temperature substantially corresponding to the temperature of the surroundings. Both the exhaust gases and the compressed air will thus be at a temperature substantially corresponding to the temperature of the surroundings when they mix. Thus a substantially optimum amount of recirculating exhaust gases and a substantially optimum amount of air can be led into the combustion engine at a high pressure. Combustion in the combustion engine with high performance and optimum reduction of nitrogen oxides in the exhaust gases is thus made possible.

The coolant in the second cooling system is thus also used for other cooling purposes. The line 26e leads coolant at substantially the temperature of the surroundings from the second cooling system to the radiator 35, in which it cools gearbox oil. The line 26g leads coolant at substantially the temperature of the surroundings to the condenser 39, in which it cools refrigerant of an air conditioning system, and the line 26h leads coolant at substantially the temperature of the surroundings to the radiator 40 to cool electrical control units of the vehicle 1. After the coolant in the second cooling system has cooled the respective components, it is brought together in the line 26b. The line 26b leads the warm coolant to the radiator elements 24, 26 for renewed cooling.

During normal operation, the control unit 31 is adapted to keeping the first three-way valve 32 and the second three-way valve 34 in positions such that no exchange of coolant takes place between the first cooling system and the second cooling system. However, the effective cooling of the compressed air and the recirculating exhaust gases may lead to ice formation in the coolers 9c, 14b. If it receives information which indicates that there is risk of ice formation or that ice has formed within either of the coolers 9c, 14b, the second control unit 31 halts the operation of the pump 27. The second control unit 31 places the first three-way valve 32 in a position such that warm coolant from the combustion engine's cooling system is led to the second cooling system via the first connecting line 30. In the second position, the first three-way valve 32 leads the warm coolant in an opposite direction to the normal direction of flow in the second cooling system. The warm coolant from the combustion engine's cooling system will thus flow in the reverse direction through the third charge air cooler 9c and the second EGR cooler 14b. The warm coolant will quickly melt any ice which has formed within the charge air cooler 9c and/or the second EGR cooler 14b. After a predetermined time or when it receives information which indicates that the ice has melted in the charge air cooler 9c and/or the second EGR cooler 14b, the second control unit 31 will return the three-way valves 32, 34 to their respective first positions. Any ice formation in the charge air cooler 10 and/or the second EGR cooler 15 can thus be eliminated easily and effectively.

The vehicle 1 is in this case equipped with an oil-cooled retarder. The retarder oil is cooled in the oil cooler element 28 by the coolant in the combustion engine's cooling system. The braking capacity of a retarder is usually limited by the ability of the cooling system to cool away the thermal energy which is generated when the retarder is activated. The second control unit 31 is adapted to receiving information when the retarder is activated. When this occurs, the second control unit 31 switches off the pump 27 in the second cooling system. The second control unit also places the three-way valves 32, 34 in a third position. The first three-way valve 32 thereupon leads warm coolant from the combustion engine's cooling system to the second cooling system via the first connecting line 30. In this case the first three-way valve 32 leads the warm coolant in so that it is circulated in the normal direction of flow in the second cooling system. The warm coolant is led from the first three-way valve 32 to the radiator elements 24 and 36, in which it is cooled by air at the temperature of the surroundings. The coolant undergoes effective cooling here before it is led to the second three-way valve 34 via the line 26i. The second three-way valve 34, which has thus also been placed in a third position, leads the coolant back to the combustion engine's cooling system via the first connecting line 33. During activation of the retarder, coolant which has cooled the oil in the oil cooler 28 is thus led partly to the combustion engine's radiator 20 and partly to the second cooling system's radiator element 24. This means that the coolant undergoes considerably improved cooling when the retarder is activated. The result is that the retarder can be activated for a significantly longer time before the coolant reaches a maximum acceptable temperature.

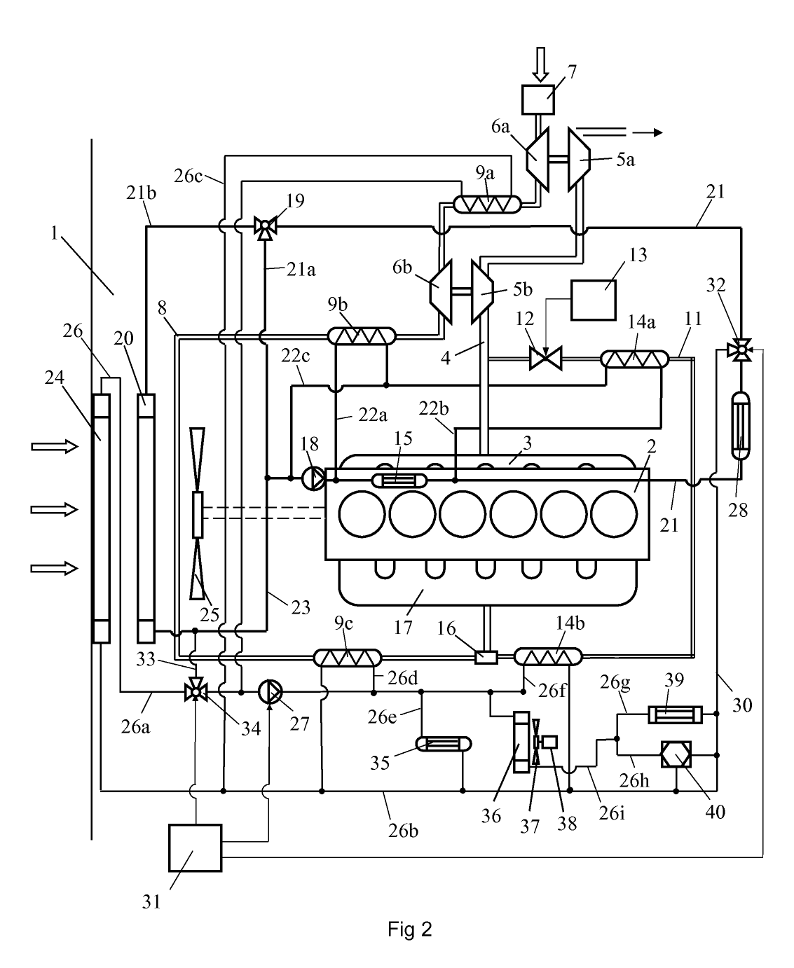

FIG. 2 depicts an alternative embodiment whereby the extra radiator element 36 is at a different location in the second cooling system. Here again, however, the coolant in the radiator element 36 is cooled by air at the temperature of the surroundings. A radiator fan 37 is provided to generate a flow of surrounding air through the radiator 36. The cooling fan 37 is driven by an electric motor 38. In this case, the lines 26c, 26d, 26e, 26f lead coolant from the line 26a to their respective coolers 9a, 9c, 14b, 35. The coolant has here been cooled in the radiator element 24 to a low enough temperature to achieve a desired cooling in the connecting coolers 9a, 9c, 14b, 35. The extra radiator element 36 thus subjects the coolant in the line 26a to a further step of cooling to a still lower temperature. The lines 26g, 26h lead coolant from the line 26i to the coolers 39, 40. Cooling with coolant at an extra low temperature is thus provided in the coolers 39, 40. The coolant from all of the coolers 9a, 9c, 14b, 35, 39, 40 is thereafter led to the line 26b for renewed cooling in the radiator element 24.

The invention is in no way limited to the embodiment described with reference to the drawing but may be varied freely within the scopes of the claims.

1. An arrangement for a supercharged combustion engine (2), which arrangement comprises an inlet line (8) adapted to leading air at above atmospheric pressure to the combustion engine (2), at least one compressor (6a, 6b) adapted to compressing the air in the inlet line (8), a first cooling system with a circulating coolant, a second cooling system with a circulating coolant which during normal operation of the combustion engine is at a lower temperature than the coolant in the first cooling system, and at least one charge air cooler (9a, 9c) applied in the inlet line (8) and adapted to being cooled by coolant from the second cooling system, characterised in that the second cooling system comprises a first radiator element (24) and a second radiator element (36) arranged in series with the first radiator element (24) in the second cooling system so that at least part of the coolant which circulates in the second cooling system undergoes two steps of temperature lowering during a single round of circulation in the second cooling system.

2. An arrangement according to claim 1, characterised in that the coolant in the second cooling system is intended to be cooled in the first radiator element (24) by air.

3. An arrangement according to claim 1 or 2, characterised in that the coolant in the second cooling system is intended to be cooled in the second radiator element (36) by air at the temperature of the surroundings.

4. An arrangement according to claim 3, characterised in that the second cooling system comprises a first line (26a) with coolant which has been subjected to a first step of cooling by the first radiator element (24), and a second line (26i) with coolant which has been subjected to a second step of cooling by the second radiator element (36).

5. An arrangement according to any one of the foregoing claims, characterised in that the second cooling system comprises a line (26b) which leads coolant back, after use, to the first radiator element (24).

6. An arrangement according to any one of the foregoing claims, characterised in that the second cooling system comprises a line (26c) adapted to leading coolant to a first charge air cooler (9a), and a line (26d) adapted to leading coolant to a further charge air cooler (9c), which lines (26c, 26d) are arranged in parallel so that they lead coolant at substantially the same temperature to the respective charge air coolers (9a, 9c).

7. An arrangement according to any one of the foregoing claims, characterised in that the second cooling system comprises at least one line (26c, 26d) adapted to leading coolant to the charge air cooler (9a, 9c), and a line (26e-h) adapted to leading coolant to a cooler (14b, 35, 39, 40) in order to cool some other medium than air.

8. An arrangement according to any one of the foregoing claims, characterised in that the first cooling system is adapted to cooling the combustion engine (2).

9. An arrangement according to any one of the foregoing claims, characterised in that it comprises a return line (11) connecting the exhaust line (4) to the inlet line (8) to make it possible, via the return line (11), to recirculate exhaust gases from the exhaust line (4) to the inlet line (8).

10. An arrangement according to claim 9, characterised in that the return line (11) comprises an EGR cooler (14a) adapted to being cooled by coolant from the second cooling system.
